(19) United States
(12) Patent Application Publication
(10) Pub. No.: US 2009/0236578 A1
(43) Pub. Date: Sep. 24, 2009

(54) TRAILER SUPPORT POST WITH SPRING SCALE

(75) Inventors: David Nirenberg, Jefferson City, TN (US); Daniel Sweeney, Morristown, TN (US); Arden Haynes, Knoxville, TN (US)

Correspondence Address: BOND, SCHOENECK & KING, PLLC, ONE LINCOLN CENTER, SYRACUSE, NY, 13202-1355, US

(73) Assignee: UNIFIED MARINE, INC., Newport, TN (US)

(21) Appl. No.: 12/410,245

(22) Filed: Mar. 24, 2009

Related U.S. Application Data
(60) Provisional application No. 61/038,801, filed on Mar. 24, 2008.
(60) Provisional application No. 61/047,233, filed on Apr. 23, 2008.
(60) Provisional application No. 61/054,255, filed on May 19, 2008.
(60) Provisional application No. 61/101,172, filed on Sep. 30, 2008.
(60) Provisional application No. 61/122,043, filed on Dec. 12, 2008.

(51) Int. Cl. B60S 9/02; B60D 1/66

(52) U.S. Cl. 254/420; 280/475

(57) ABSTRACT

A trailer jack including trailer securing hardware, a support post assembly and a wheel. The support post assembly includes jacking hardware and a spring scale. The trailer securing hardware secures a trailer so that it is supported by the support post assembly and the spring scale indicates the tongue weight of the trailer. The wheel allows the trailer to be moved around when it is hooked up to the jack. In one kind of design, the spring is located between the trailer securing hardware and the wheel. In another kind of design, the spring is located above the trailer securing hardware, distally from the wheel.

### RELATED APPLICATION

The present application claims priority to the U.S. provisional patent applications: (i) U.S. provisional patent application No. 61/038,801, filed on Mar. 24, 2008; (ii) U.S. provisional patent application No. 61/047,233, filed on Apr. 23, 2008; (iii) U.S. provisional patent application 61/054,255 filed on May 19, 2008; (iv) U.S. provisional patent application 61/101,172 filed on Sep. 30, 2008; and (v) U.S. provisional patent application 61/122,043 filed on Dec. 12, 2008; all of the foregoing patent-related document(s) are hereby incorporated by reference herein in their respective entirety(ies).

### BACKGROUND OF THE INVENTION

1. Field of the Invention

The present invention relates to trailer support posts and more particularly to trailer jacks and even more particularly to trailer jacks with wheel(s).

2. Description of the Related Art

Trailer jacks including jacking hardware and trailer securing hardware are conventional. For example, many conventional trailer jacks include jacking hardware using a crank and a worm gear. In operation: (i) the jacking hardware is operated to adjust the height of the trailer securing hardware matches the height of corresponding jack securing hardware on a trailer; (ii) the jack hitching hardware of the trailer is hitched to the trailer hitching hardware of the jack; and (iii) the jacking hardware is subsequently operated to raise or lower to the trailer securing hardware and the trailer secured to it for purposes such as hitching the trailer to a trailer hitch on a towing vehicle. Some trailer jacks include and are supported on wheel(s). This is advantageous because it allows the trailer to be moved around while it is supported on the trailer jack.

U.S. Pat. No. 2,970,820 (“Sepich”) discloses a construction material mixer designed to be towed by a vehicle. The mixer includes an upright standard 12 for supporting the front end of the mixer. The upright standard includes a spring scale 20, 22, 29, 33, 37. The Sepich mixer does not appear to include jacking hardware. Importantly, the upright standard 12 of Sepich does not include and is not supported by wheel(s). Rather, it is supported by a flat plate that rests on the ground.

U.S. Pat. No. 3,797,594 (“Chaffee”) discloses an apparatus carried by the tongue of a trailer to indicate tongue weight and thereby assist in distributing the weight of the cargo in the trailer. The Chaffee apparatus includes a screw jack, a ground engaging wheel and a trailer tongue dead weight measuring device. More specifically, the weight measuring device is disclosed to be a hydraulic weight measuring device that measures weight based on fluid pressure. It is believed that Chaffee may have decided to use a hydraulic scale because it is supported on a wheel. More specifically, the use of a wheel introduces lateral forces which would have taught away from using a spring scale in place of the hydraulic scale.

Other publications which may be of interest may include: (i) U.S. design Pat. No. 363,242 (“Scanlon”); (ii) U.S. Pat. No. 4,056,155 (“Wahl”); (iii) U.S. Pat. No. 478,699 (“Kovsky”); (iv) US Patent Application 2006/0032679 (“Wilson”); (v) U.S. Pat. No. 6,494,478 (“MacKarvich”); and/or (vi) U.S. Design Pat. No. D501,975 (“Marsh”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

According to the present invention, a trailer jack including trailer securing hardware, a support post assembly and a wheel. The support post assembly includes jacking hardware and a spring scale. The trailer securing hardware secures a trailer so that it is supported by the support post assembly and the spring scale indicates the tongue weight of the trailer. The wheel allows the trailer to be moved around when it is hooked up to the jack. In one kind of design, the spring is located between the trailer securing hardware and the wheel. In another kind of design, the spring is located above the trailer securing hardware, distally from the wheel.

Various embodiments of the present invention may exhibit one or more of the following objects, features and/or advantages:

(i) facilitates determination of tongue weight of a trailer

(ii) facilitates optimal distribution of cargo in a trailer;

(iii) allows trailer to be moved when it is supported on a trailer jack by using wheel(s) to support the trailer jack

(iv) allows a trailer tongue to be moved up and down, for example moved up into position to be hitched to a towing vehicle;

(v) uses a sturdy, accurate, reliable and/or inexpensive spring scale to determine weight (as contrasted with other types of scales, such as hydraulic scales);

(vi) prevents lateral forces from damaging trailer jack components;

(vii) prevents lateral forces from causing an inaccurate weight reading;

(viii) designs with scale above the trailer securing hardware are easier to read (for example, a user may not need to bend down to read the weight); and/or

(ix) easily maneuverability by use of a shopping cart type wheel geometry.

According to the present invention, a trailer support apparatus supports at least a portion of a trailer, such as the trailer tongue. The apparatus is designed for use with a trailer including support securing hardware. The trailer support apparatus includes trailer securing hardware, a support post assembly and a set of wheel(s). The trailer securing hardware is shaped and sized to disengagably engage the support securing hardware. The support post assembly is mechanically connected (see DEFINITIONS section) to the trailer securing hardware. The support post assembly includes a spring scale. The spring scale includes a spring (see DEFINITIONS section) and spring compression indication hardware (see DEFINITIONS section). The spring and spring compression indication hardware are located, shaped and sized so that compression of the spring will be indicated by the spring compression indication hardware. The set of wheel(s) includes at least one wheel and is mechanically connected to the support post assembly. The trailer securing hardware, the support post assembly and the set of wheels are located, shaped and sized so that: (i) the trailer support apparatus can rest on the set of wheel(s) in rolling contact with the ground, (ii) the support post assembly supports the trailer securing hardware above the ground to thereby support at least a portion of the weight of the trailer, and the weight of the trailer compresses the spring.

According to a further aspect of the present invention, a trailer jack supports and jacks a trailer tongue. The jack includes trailer securing hardware, a lower jack assembly defining a central axis, an upper jack assembly, jacking hardware, and a wheel mechanically connected at a bottom portion of the lower jack assembly and thereby defining up and down directions along the central axis. The trailer securing hardware is mechanically connected to the upper jack assembly. The jacking hardware mechanically connects the upper jack assembly to the lower jack assembly and is shaped, sized, located and or connected so that a user may operate the jacking hardware to move the upper jack assembly in the up and down directions relative to the lower jack assembly. The lower jack assembly includes a spring scale. The spring scale includes a spring and spring compression indication hardware, with the spring and spring compression indication hardware being located, shaped and sized so that compression of the spring will be indicated by the spring compression indication hardware.

According to a further aspect of the present invention, a trailer jack supports and jacks a trailer tongue. The jack includes trailer securing hardware, a lower jack assembly defining a central axis, an upper jack assembly, jacking hardware, and a wheel mechanically connected at a bottom portion of the lower jack assembly and thereby defining up and down directions along the central axis. The trailer securing hardware is mechanically connected to the upper jack assembly. The jacking hardware mechanically connects the upper jack assembly to the lower jack assembly and is shaped, sized, located and or connected so that a user may operate the jacking hardware to move the upper jack assembly in the up and down directions relative to the lower jack assembly. The upper jack assembly includes a spring scale. The spring scale includes a spring and spring compression indication hardware. The spring and spring compression indication hardware are located, shaped and sized so that compression of the spring will be indicated by the spring compression indication hardware.

### BRIEF DESCRIPTION OF THE DRAWINGS

The present invention will be more fully understood and appreciated by reading the following Detailed Description in conjunction with the accompanying drawings, in which:

FIG. 1 is a schematic view of a first embodiment of a trailer jack according to the present invention;

FIG. 2 is a schematic view of a second embodiment of a trailer jack according to the present invention;

FIG. 3 is a side orthographic view of a third embodiment of a trailer jack according to the present invention;

FIG. 4 is a perspective view of the third embodiment jack in assembly with a simulator;

FIG. 5 is an exploded view of the third embodiment jack;

FIG. 6 is a schematic view of a portion of the internal workings of the third embodiment jack;

FIG. 7 is another schematic view of a portion of the internal workings of the third embodiment jack;

FIG. 7 is an orthographic front view of a portion of a cup member of the third embodiment jack;

FIG. 8 is an orthographic side view of a portion of the cup member of the third embodiment jack;

FIG. 9 is an orthographic front view of a portion of the third embodiment jack in a partially assembled state;

FIG. 10 is another orthographic front view of a portion of the third embodiment jack in a partially assembled state;

FIG. 11 is another orthographic front view of a portion of the third embodiment jack in a partially assembled state;

FIG. 12 is an exploded view a fourth embodiment of a trailer jack according to the present invention;

FIG. 13 is a schematic view of a portion of the internal workings of the fourth embodiment jack;

FIG. 14 is another schematic view of a portion of the internal workings of the fourth embodiment jack;

FIG. 15 is a perspective view of a portion of the fourth embodiment jack; and

FIG. 16 is a perspective view of a portion of the fourth embodiment jack.

### DETAILED DESCRIPTION OF THE INVENTION

FIG. 1 shows a trailer jack 100 including: trailer securing hardware 101; a support post assembly 102; and a set of wheels 103.

The trailer securing hardware is adapted to secure a portion of a trailer (usually a trailer tongue) to the jack. The trailer securing hardware may be of any type now known or to be developed in the future. The shape, size, location and/or number of parts of the trailer securing hardware will generally depend on the type of trailer (for example, boat towing trailer, construction work trailer, automobile towing trailer, cargo trailer) with which the jack is designed to be used.

The support post assembly includes: jack hardware 104; spring 106 and weight indicator 105.

Some embodiments of the present invention may not include the jack hardware, but these embodiments are not necessarily preferred because this type of support post would not be able to lift or lower the trailer tongue.

The spring is preferably a helical spring, but other types of mechanical springs are possible. Importantly, the spring is located, sized, shaped and/or mechanically connected so that it will: (i) compress as downward force on the trailer tongue is increased; and (ii) decompress as downward force on the trailer tongue decreases. Preferably the spring will compress and decompress in a predictable way, even as it is used through many duty cycles or even somewhat overloaded. Preferably the spring is highly corrosion resistant so that its properties and physical integrity remain substantially constant over time. Preferably the spring is sized, shaped, located and/or connected so that it is at least approximately at its rest length when there is no weight on the trailer tongue, but this is not necessarily required.

The weight indicator indicates the weight of the portion of the trailer tongue that is connected to the trailer securing hardware. This may be as simple as an assembly of two parts that move relative to each other to visually indicate weight to a user. On the other hand, the weight indicator could be as complicated as a device that converts the weight into digital data and communicates it to local and/or worldwide communication networks in a wired and/or wireless fashion. Other types of indications, such as audio indications are also possible. Although most preferred embodiments of the present invention will make an indication based on the length that the spring is compressed, it is also possible to use other characteristics of the spring motion characteristics (for example, spring length change velocity, spring length change acceleration) alternatively, or additionally, to spring length change distance.

The set of wheels may include any type of wheels now known or developed in the future, such as disc shaped wheels, roller shaped wheels, spherical shaped wheels, wheels with pneumatic tires, etc. The use of multiple wheels, as in set of wheels 103, can help prevent lateral forces (that is forces acting at an angle to the up-down direction). Nevertheless, it may be preferable to use only a single wheel because this can: (i) decrease the jack size and/or footprint; (ii) facilitate easier maneuverability; and/or (iii) allow the jack to travel over rougher terrain. As will be explained allow, some embodiments of the present invention are well-adapted to deal with lateral forces so that a single wheel may be used instead of multiple wheels.

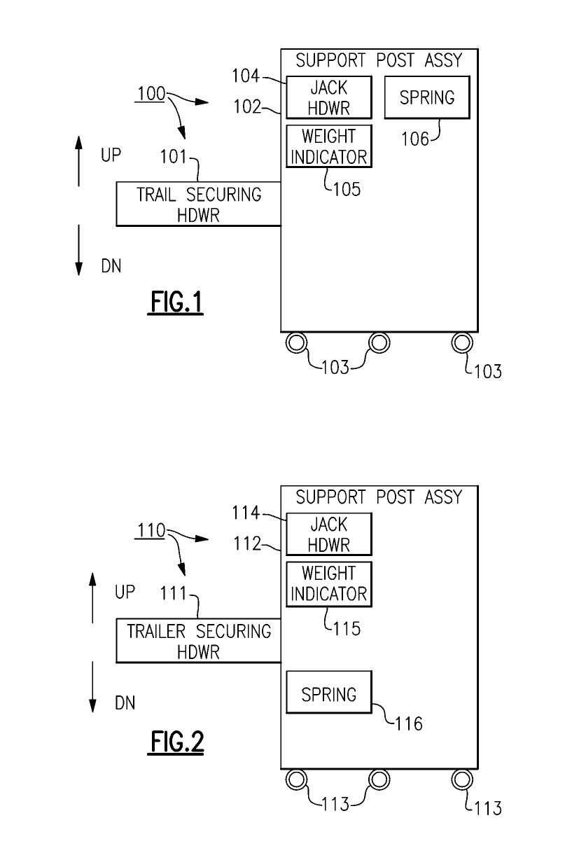

FIG. 2 shows a trailer jack 110 including: trailer securing hardware 111; a support post assembly 112; and a set of wheels 113. The support post assembly includes: jack hardware 114; spring 116 and weight indicator 115. Trailer jack 110 is different than trailer jack 100 because the spring 116 is located below the trailer securing hardware 111 in jack 110, rather than above the trailer securing hardware 101 as in jack 100. Each of these alternative kind of designs has its own potential advantages as will be further discussed below in connection with other embodiments of the present invention. The spring is preferably coaxially aligned with a central axis defined by the support post portion(s) of the support post assembly, but this is not necessarily required. For example, multiple springs could be used that are symmetrically, or even non-symmetrically distributed about the central axis of the support post portion(s). Preferably the spring compresses and decompresses substantially along the up-down direction, but this is not necessarily required. For example, if the trailer securing hardware is designed so that the secured trailer exerts force components that are not parallel to the up-down direction (for example, rotational force components, linear force components at an angle to the up-down direction) then the spring may be oriented to most optimally deal with these forces.

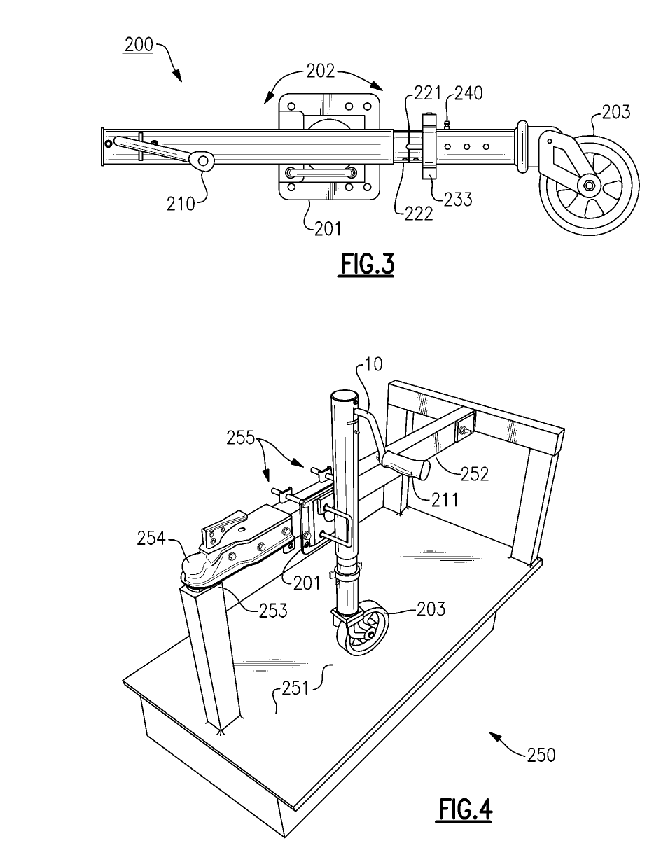

As shown in FIGS. 3 to 11, trailer jack 200 includes: trailer securing hardware 201; support post assembly 202; and wheel 203. Support post assembly includes: upper support post 204; threaded jacking rod 205; middle support post 206; spring 207; lower support post 208; pivoting wheel connection 209; jacking crank 210; crank handle 211; cup assembly 220; collar assembly 230; and grease fitting 240. Cup assembly 220 includes: demarcation 221; cup member 222; axial alignment bolt 223; and threaded receptacle 224. Cup member 222 includes: cup portion 222a; sleeve portion 222b; two (2) twist-to-lock tracks 225; two (2) first axial tracks 226; and two (2) second axial tracks 227. Collar assembly includes: twist-to-lock bolt 231; first collar member 232; and second collar member 233.

FIG. 4 shows jack 200 a assembled with a simulator 250 which simulates a trailer tongue, a towing vehicle and the ground. Simulator includes: ground plane member 251; trailer tongue member 252; trailer hitch member 253; tow vehicle hitch member 254; and jack securing hardware 255. As show in FIG. 4, when trailer securing hardware 201 of jack 200 is secured to jack securing hardware 255, then the jack is in an upright position with its central axis aligned with the up-down direction and wheel 203 resting on the ground. The jacking hardware of jack 200 includes threaded jacking rod 205; jacking crank 210 and crank handle 211, as well as other conventional jacking components. Various embodiments of the present invention that include jacking hardware of any type now known or to developed in the future. In use, the jacking hardware of jack 200 is operated to raise trailer securing hardware 201, jack securing hardware 255 and trailer tongue member 252 and vehicle hitch 254 relative to the ground 251. More specifically, the vehicle hitch 254 is raised up over trailer hitch 253 and then lowered down onto it.

In practice, as a user is preparing to raise the vehicle hitch using the jack, the location of demarcation 221 relative to the top of second collar member 233 (see FIG. 3) will provide a visual indication of tongue weight. This indication of weight is very helpful because towing vehicles have a maximum rated tongue weight, and it can be dangerous to tow a trailer when the tongue weight exceeds the maximum rated tongue weight. If tongue weight indicated by jack 200 exceeds the maximum rated tongue weight, then remedial measured can be taken including the following: (i) redistribute cargo in the trailer in a direction away from the trailer tongue; (ii) remove cargo from the trailer; and/or (iii) get a towing vehicle with a greater maximum tongue weight rating.

If a jack has only a single weight demarcation, such as demarcation 221 of jack 200, then it is preferably used in connection with a towing vehicle having a corresponding maximum rated tongue weight. Alternatively, a more highly granulated weight indication may be provided, which would allow the same jack to be used with towing vehicles having a variety of maximum rated tongue weights. FIG. 7 shows an example of a more highly granulated weight indication sub-system.

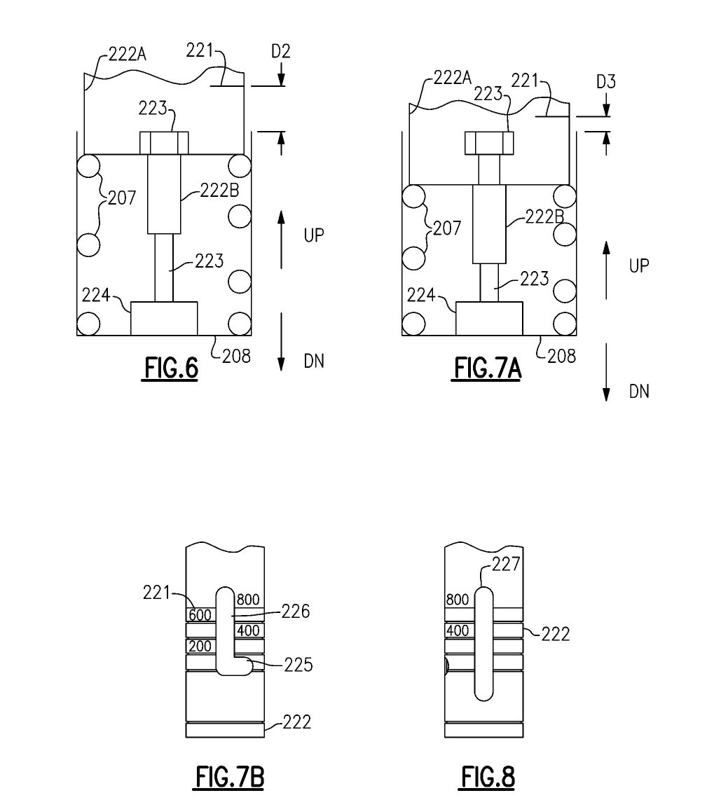

FIGS. 6 and 7 (schematic views, not to scale) show how spring 207 compresses under a load and how the weight indication sub-system components 221, 222, 208 provide a visual indication of weight based on the compression of the spring. In FIG. 6, the spring 207 is in a relatively uncompressed state and its coils (shown schematically in cross section as a series of circles) are relatively far apart. The spring rests at the bottom of lower support post 208. The spring is prevented from further decompression by physical interference with cup portion 222a of cup member 222. In turn, cup member 222 is prevented from further upwards direction displacement by the head of axial alignment bolt 223. In turn, the axial alignment bolt is prevented from further upwards displacement by threaded engagement with threaded receptacle 224 which is mounted at the bottom of lower support post 208. In the state of FIG. 6, the distance between the top of lower support post 208 and demarcation 221 is D2. This large distance D2 provides a visual indication that the spring is not compressed and that there is therefore substantially no tongue weight on the jack.

FIG. 7 shows what happens when a tongue weight load is applied. The cup portion 222a of cup member 222 pushes down on the top of spring 207, thereby causing it to compress by moving its coils of its helix structure closer together. As this compression happens, downward axial displacement of the spring in blocked directly by physical interference with lower support post, indirectly by pivoting connection 209 and wheel 203 and, ultimately, by the ground upon which the wheel rests. As the spring compresses, cup member 222 moves down on top of it under influence of the tongue weight loading.

As this downward motion happens, sliding engagement between the sleeve portion 222b of cup member 222 and axial alignment bolt 223 ensures that the cup moves squarely down in the axial direction. This straight-down movement prevents any lateral forces from causing the cup member to go out of coaxial alignment with the lower support post as it slides further into the interior space of the lower support post, which, in turn, prevents seizing or binding in the telescoping motion between the cup member and the lower support post. This prevention of seizing or binding prevents mechanical shocks and/or component damage. This use of an axial alignment member and engaging sleeve is one preferred way to incorporate a spring scale into a support posts that sits on a wheel, despite the lateral forces that may be caused by the use of a wheel. In this embodiment the axial alignment bolt and its engaging sleeve are circular in cross-section, but other cross-sectional profiles may be used, such as mating profiles, like polygons, that are shaped to prevent the cup member from rotating about the central axis with respect to the axial alignment member. Also, multiple axial alignment members and sleeves could be used, so long as they do not physically interfere with the compression and decompression of the spring.

As shown in FIG. 7, the distance between demarcation 221 and the top of the lower support post has decreased from D2 to D3. This is a visual indication of tongue weight for users of the trailer jack.

FIGS. 3 and 8 show the structures used to prevent relative rotation about the central axis between lower support post 208 and cup 222. Specifically, set screws (not shown) extend through the peripheral wall of lower support post 208 lower support post 208. In the interior space of lower support post, ends of the set screws extend into second axial tracks 227 of cup member 222. The second axial tracks are spaced apart 180 degrees in the angular direction so that the set screws oppose each other in the angular direction. Because second axial tracks extend in the axial direction, they allow axial direction motion, while preventing relative rotation about the central axis by physically interference between the set screws and the sides of the tracks. Alternatively, relative rotation between the cup member and the lower support post could be prevented by other structures now known or to be developed in the future. As a further alternative, relative rotation between the cup member and the lower support post could be unconstrained.

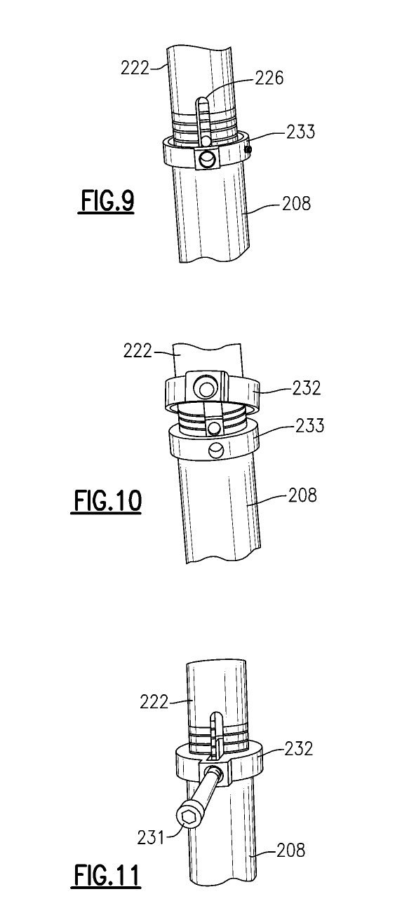

FIGS. 3, 5, 7 and 9 to 11 show how collar assembly 230 allows the spring scale components 221, 222 to be locked relative to the lower support post. Such locking may be desirable to save wear and tear on the screw and/or other components when the function of the spring scale is not needed. As shown in FIG. 9, second collar member 233 is secured to the tope end of lower support post 208 so that it is rotatable relative to the lower support post about the central axis, but otherwise constrained to the top of the lower support post. As shown in FIG. 7 the second collar member is rotated to be angularly aligned with first axial tracks 226 of cup member 222. The first axial tracks are preferably defined in the cup member to be (i) 180 degrees apart from each other in the angular direction; and (ii) 90 degrees apart from the second axial tracks 227. As shown in FIG. 10, first collar member 232 is then placed over second collar member 233 so that its holes (spaced angularly apart 180 degrees) angularly align with: (i) corresponding holes in the second collar member; and (ii) first axial tracks 226 in the cup member. As shown in FIG. 11, twist-to-lock bolt 231 is: (i) inserted through one of the holes in the first collar member, the corresponding holes in the second collar member and the first axial tracks; and (ii) threadably engaged with threads in the other hole in the first collar member 232.

Once assembled, the locking and unlocking operation of collar assembly 230 is best understood with reference to FIG. 7. Specifically, when first inserted, the engagement between first axial tracks 226 and the twist-to-lock bolt 231 allows cup member 222 to move upon and down under the countervailing influences of spring 207 and weight of the trailer tongue. While the first axial tracks and the twist-to-lock bolt remain axially aligned the spring scale is unlocked and operational. However, when the twist-to-lock bolt is at its lowest position in the first axial tracks (preferably corresponding to an unloaded condition), a user may rotate the collar assembly about the central axis to lock the scale. When a user twists the collar assembly, the twist-to-lock bolt rotates angularly within the twist-to-lock tracks 225 so that the twist-to-lock bolt is no longer angularly aligned with the first axial tracks. When this happens, the cup member can no longer travel downwards with respect to the collar assembly, even if weight is put on the trailer tongue, because the top of the twist-to-lock tracks physically interfere with the twist-to-lock bolt. When a user twists the collar assembly back into angular alignment with the first axial tracks, the cup member is able to move axially again and the scale can operate again. Alternatively, other locking mechanisms could be used. As a further alternative, the locking mechanism may be omitted entirely.

Although not shown in the Figures, drainage holes may be provided at the bottom side of cup portion 222a of cup member 222 around sleeve portion 222b. It is noted that some preferred embodiments of the present invention include drainage holes and/or other drainage structures because a spring scales generally do not require the pressurized fluid tight seals. As discussed above, these types of fluid tight seals, and their associated expense and potential for failure, are required in the Chaffee apparatus (discussed above).

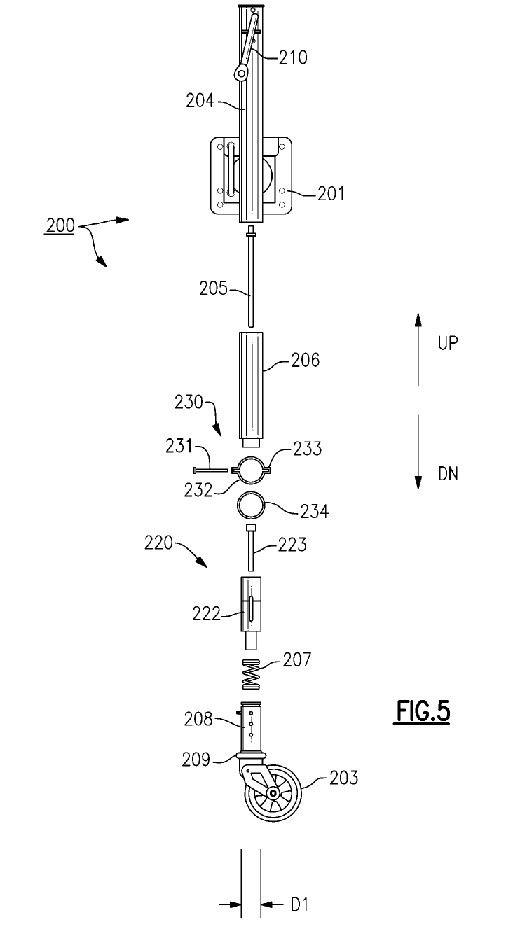

As shown in FIG. 5, wheel 203 is a shopping cart type where: (i) the wheel which has a rotational axis that is offset from the central axis of the jack by distance D1; and (ii) the wheel can also pivot about the central axis. This design enhances maneuverability of the jack, but it may increase lateral forces within support post assembly 202. Fortunately, as discussed above, the design of jack 200 allows it to deal with lateral forces without causing damage or operational issues.

Some exemplary specifications and/or characteristics for constructing jack 200 include the following: (i) axial length of sleeve portion 222b of cup member 222=1.54 inches; (ii) cup member 222 formed by welding sleeve portion 222b to cup portion 222a; (iii) axial alignment bolt is 4.125 inches long, 0.62 inches in diameter and 3.5 inches not including its head; (iv) axial alignment bolt has a hex head suitable to be turned by an Allen wrench; (v) cup member and supporting posts have a wall thickness of 0.14 inches; and (vi) cup member and supporting posts all made from same material (preferably steel).

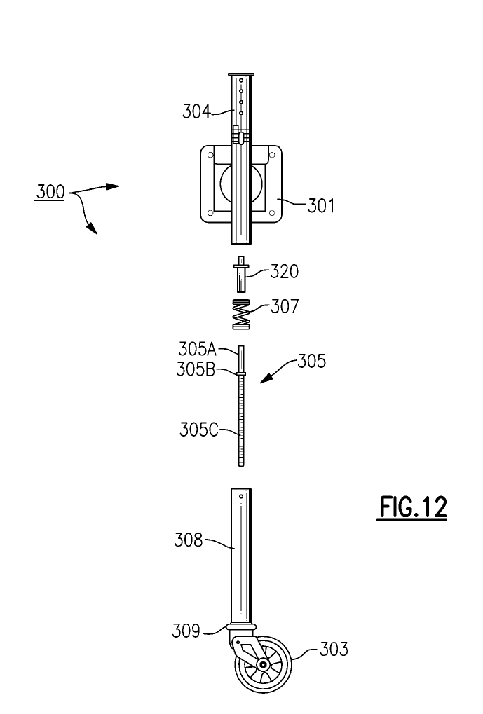

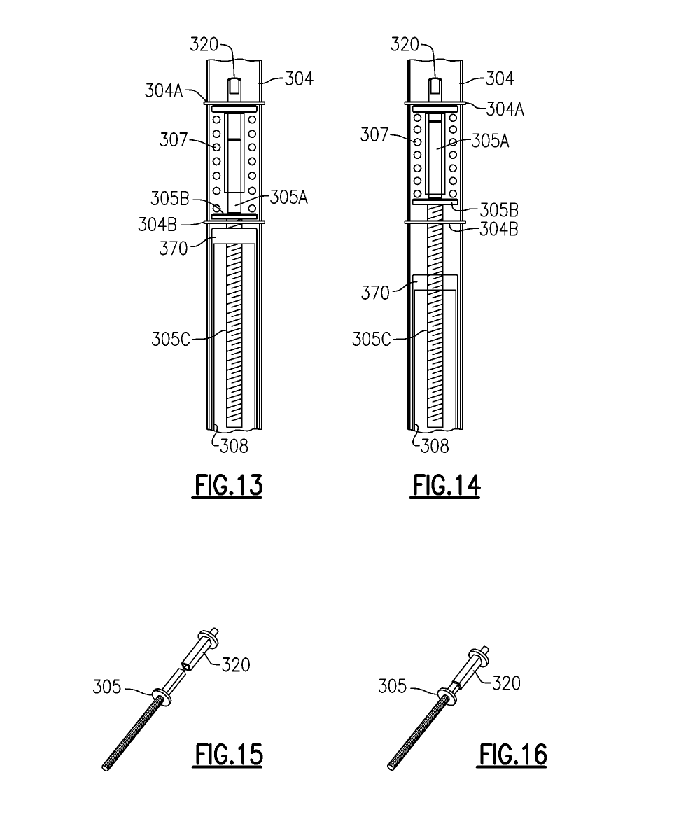

As shown in FIGS. 12 to 16, another embodiment of a trailer jack 300 according to the present invention includes: trailer securing hardware 301; wheel 303; upper support post assembly 304; first jacking member 305; spring 307; lower support post 308; pivoting wheel connection 309; second jacking member 320; and threaded cap 370. The upper post assembly 304 includes upper stop hardware 304a and lower stop hardware 304b. The first jacking member includes upper portion 305a; flange 305b; and threaded portion 305c. As shown in FIGS. 13 and 14, spring 307 is located near the top of jack 300, with at least part of the spring preferably being located above trailer securing hardware 301. This can be advantageous because is reduces or eliminates the lateral forces where components 305a, 320 slidingly engage under countervailing axial direction forces imparted by the spring of the spring scale and by the tongue weight. This facilitates the use of a spring scale, especially a spring scale balanced on wheels, and even more especially a spring scale balanced on a single wheel.

It is further noted that in this embodiment, the spring travels within an assembly that moves up and down as the jack is operated to move the trailer securing hardware up and down. Although this will often mean that the spring is located near the top of the jack, there may be embodiments of the present invention where the spring is located at a relatively low location of the jack, but still moves up and down as the jack is operated. This idea of the spring moving up and down as jacking occurs should be contrasted with above-described trailer jack 200 where the spring does not move up and down as jacking occurs. Conversely, this type of design will often mean that the spring is located near the bottom of the jack (as it is in jack 200), but there may designs where the spring is relatively high up in the jack but still maintains its spring bottom at a fixed height above the ground even when jacking occurs.

In jack 300, certain jacking components 305, 320 also serve double duty as components of the spring scale. More specifically, as shown in FIGS. 15 and 16, the jack crank (not shown) and/or gear train (not shown) turns second jacking member 320 about its central axis. Second jacking member 320 includes a rectangular recess that slidingly engages a correspondingly shaped upper portion 305a (see FIGS. 13 and 14) of first jacking member 305. As shown in FIGS. 13 and 14, this sliding engagement means that first jacking member 305 and second jacking member can move relative to each other in the axial direction (or up-down direction) of the jack. However, as best shown in FIGS. 13 and 14, the engaging rectangular cross-sectional profiles of these two engaging portions mean that rotation of the first jacking member will drive the second jacking member to rotate. Other cross-sectional shapes besides a rectangle could be used, so long as the shapes mate so that the second member can drive the first member to rotate along with it about the central axis. Alternatively, the rotational constraint, along with axial direction non-constraint) could be provided by other structure such as a key and slot arrangement. As shown in FIGS. 13 and 14, when the first jacking member rotates, its threaded engagement with threaded cap 370 will cause the first jacking member to travel up or down in the axial direction depending upon the clockwise or counterclockwise direction of the rotation.

As shown in FIGS. 13 and 14, when the first jacking member travels axially upwards, flange 305b will force spring 307 axially upwards. In turn, spring 307 forces second jacking member 320 upwards. In turn, second jacking member forces upper stop hardware 304a upwards. In turn, this forces upper support post assembly 304 upwards as a whole and causes it to move telescopically upwards away from lower support post 308. In turn, this raises trailer securing hardware 301 that is mechanically connected to the upper support post assembly. In turn this will raise any trailer tongue that may be secured to the trailer securing hardware. Of course, by rotating the second jacking member in the opposite rotation direction, all the components move downward through opposite corresponding motions, at least until lower stop hardware 304b reaches and is stopped by threaded cap 370.

The operation of the spring scale of jack 300 will now be described. FIG. 13 shows jack 300 in the fully unloaded position. Spring 307 is decompressed to at or near its rest position. Preferably, the spring is actually slightly compressed forcing first jacking member down against lower stop hardware 304b and also forcing second jacking member up against upper stop hardware 304a. Preferably, the upper stop hardware and lower stop hardware take the shape of metal discs, but other stop geometry could be used so long as they limit the relative axial range of motion of the jacking members by physical interference. Although the stop hardware may not be required in all embodiments of the present invention, it prevents the jacking members from becoming completely disengaged with each other and also prevents wiggling and rattling as the jack is carried around by a user.

FIG. 14 shows what happens when a tongue weight is applied to trailer securing portion 301 and support post assembly 304. Specifically, upper stop hardware 304a pushes downward on second jacking member 320. In turn, second jacking member pushes downward on the top of spring 307. However, the bottom of spring 307 is constrained from travelling axially downwards under influence of this loading force by flange 305b of first jacking member 305 because first jacking member 305 is rigidly constrained in the axial direction by its engagement with threaded cap 370 and lower support post 308. This means that the loading force will act to compress the spring. As the spring compresses, the top of spring 307 moves downward, and second jacking member, which is resting on the top of the spring moves downward with the top of the spring. In turn, upper stop hardware 304a moves down with the second jacking member. In turn, the entire upper support post assembly 304 and the trailer securing means, which is mechanically connected to the upper support post assembly, moves downward as well. Because the second jacking member moves downward as the spring compresses, but the first jacking member does not, the rectangular recess in second jacking member slides down over upper portion 305a of first jacking member 305 to accommodate the relative axial motion of the jack components caused by the trailer tongue loading.

Of course, the spring scale of jack 300 requires not just spring motion, but also an indication of the spring motion. There are many ways, now known or to developed in the future, of providing such an indication. The currently preferred structure for providing an indication in the context of jack 300 is to provide a window in the support post portion of upper support post assembly 304 so the position of flange 305b relative to the upper support post is visible through the window. Preferably, the window has demarcations along its edge to indicate a scale of units of weight.

As greater trailer tongue weight is applied the spring will continue to compress until flange 305b of first jacking member physically prevents further downward motion of second jacking member 320 the weight indication would indicate that the maximum rated weight for the jack has been reached or exceeded. Preferably, this maximum rated weight corresponds to a maximum rated tongue weight common to many potential towing vehicles.

Some exemplary specifications and/or characteristics for constructing jack 300 include the following: (i) second jacking member 320 is a single machined piece; (ii) first jacking member 305 is a single machined piece; (iii) although there may be suitable off the shelf springs, many of these do not compress enough to give a meaningful weight reading at least without the use of additional intermediate indication components; (iv) spring thickness=0.28 inch; (v) spring material is standard spring steel; (v) spring height at rest position is 3.162 inches; (vi) spring is characterized by linear compression in response to loading force; (vii) spring deflection curve is 0.3 inches per 200 pounds of force; (viii) outer spring diameter=1.776 inches; (ix) spring inner diameter=1.195 inches; (x) first and second jacking members preferably made of steel; (xi) nominal clearance between upper portion 305a and engaging recess in second threaded jacking member is 0.025 inches; (xii) threaded cap attached to lower supporting post by a crimp connection; and (xiii) threaded portion 305c is preferably a standard jack thread.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, force fit connections, friction fit connections, connections secured by engagement added by gravitational forces, quick-release connections, pivoting or rotatable connections, slidable mechanical connections, latches and/or magnetic connections).

spring: any type of mechanical spring now known or to be developed in the future without regard to: (i) spring geometry (for example helical, leaf spring), (ii) spring material(s), and/or (iii) whether the spring is a single unitary piece; compressible hydraulic assembles are not herein considered as “mechanical springs” or “springs.”

spring compression indication hardware: any hardware that indicates compression of a spring in any matter now known or to be developed in the future, without regard to: (i) the nature of the indication (for examples, visual, audio, computer readable data communication signal, dial indicator, linear indicator), (ii) the aspect of compression indicated (for examples, spring compression distance, spring compression velocity, spring compression acceleration); (iii) degree of precision of indication (for examples, a simple binary indication that a maximum rated weight threshold has been reached or exceeded, a rotary dial with separate demarcations for each unit of weight).

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A trailer support apparatus for supporting at least a portion of a trailer including support securing hardware, the trailer support apparatus comprising:
trailer securing hardware shaped and sized to disengagably engage the support securing hardware;
a support post assembly mechanically connected to the trailer securing hardware, the support post assembly comprising a spring scale, the spring scale comprising a spring and spring compression indication hardware, with the spring and spring compression indication hardware being located, shaped and sized so that compression of the spring will be indicated by the spring compression indication hardware; and
a set of wheel(s) comprising at least one wheel and mechanically connected to the support post assembly;
wherein the trailer securing hardware, the support post assembly and the set of wheels are located, shaped and sized so that:
the trailer support apparatus can rest on the set of wheel(s) in rolling contact with the ground,
the support post assembly supports the trailer securing hardware above the ground to thereby support at least a portion of the weight of the trailer, and
the weight of the trailer compresses the spring.

2. The apparatus of claim 1 wherein:
the location of the set of wheel(s) and the trailer securing hardware defines up and down directions; and
the spring is located at least substantially below the trailer securing hardware.

3. The apparatus of claim 1 wherein:
the location of the set of wheel(s) and the trailer securing hardware defines up and down directions; and
the spring is located at least substantially above the trailer securing hardware.

4. The apparatus of claim 1 wherein:
the location of the set of wheel(s) and the trailer securing hardware defines up and down directions; and
the support post assembly further comprises jacking hardware structured, sized and located to adjust a distance between the set of wheel(s) and the trailer securing hardware in the up and down directions.

5. The apparatus of claim 1 wherein:
the support post assembly defines an up-down axis;
the set of wheel(s) consists of a single wheel that rotates about a rotational axis;
the rotational axis is at least approximately perpendicular to the up-down axis; and
the rotational axis is offset from the up-down axis by an offset distance.

6. A trailer jack for supporting and jacking a trailer tongue, the jack comprising:
trailer securing hardware;
a lower jack assembly defining a central axis;
an upper jack assembly;
jacking hardware; and
a wheel mechanically connected at a bottom portion of the lower jack assembly and thereby defining up and down directions along the central axis;
wherein:
the trailer securing hardware is mechanically connected to the upper jack assembly;
the jacking hardware mechanically connects the upper jack assembly to the lower jack assembly and is shaped, sized, located and or connected so that a user may operate the jacking hardware to move the upper jack assembly in the up and down directions relative to the lower jack assembly; and
the lower jack assembly comprises a spring scale comprising a spring and spring compression indication hardware, with the spring and spring compression indication hardware being located, shaped and sized so that compression of the spring will be indicated by the spring compression indication hardware.

7. The jack of claim 6 wherein the lower jack assembly comprises:
a first member comprising:
a force transmission portion located to rest on the spring and sized, shaped and located to transmit trailer tongue weight forces from the upper jack, and
first axial alignment hardware; and
second axial alignment hardware sized, shaped, located and/or connected to engage with the first axial alignment hardware so that the first member can move in a direction at least substantially parallel to the central axis and is prevented from moving laterally.

8. The jack of claim 7 wherein:
the first axial alignment hardware is in the form of a sleeve;
the second axial alignment hardware is in the shape of a post extending in the axial direction; and
coaxial sliding engagement between the first axial alignment hardware and the second axial alignment hardware allows the first member to move in a direction at least substantially parallel to the central axis and prevents it from moving laterally.

9. The jack of claim 8 wherein:
the spring is a helical spring defining a central opening;
the force transmission portion is in the shape of a cup;
the cup comprises a generally disc shaped cup bottom portion;
the cup bottom portion is located, shaped and sized to rest on top of the spring; and
the sleeve extends in a downward direction from the cup bottom portion into the central opening of the spring.

10. The jack of claim 9 wherein:
the cup further comprises an upstanding peripheral wall;
the upstanding peripheral wall defines a demarcation; and
the spring compression indication hardware comprises the demarcation.

11. The jack of claim 6 further comprising a pivoting wheel connection sized, shaped, located and connected to mechanically connect the wheel to the lower jack assembly so that a rotational axis of the wheel is at least substantially perpendicular axis, and so that the wheel is free to pivot about the central axis.

12. The jack of claim 11 wherein the wheel is sized, shaped, connected and/or located so that the rotational axis of the wheel is offset from the central axis.

13. A trailer jack for supporting and jacking a trailer tongue, the jack comprising:
trailer securing hardware;
a lower jack assembly defining a central axis;
an upper jack assembly;
jacking hardware; and
a wheel mechanically connected at a bottom portion of the lower jack assembly and thereby defining up and down directions along the central axis;
wherein:
the trailer securing hardware is mechanically connected to the upper jack assembly;
the jacking hardware mechanically connects the upper jack assembly to the lower jack assembly and is shaped, sized, located and or connected so that a user may operate the jacking hardware to move the upper jack assembly in the up and down directions relative to the lower jack assembly; and
the upper jack assembly comprises a spring scale, the spring scale comprising a spring and spring compression indication hardware, with the spring and spring compression indication hardware being located, shaped and sized so that compression of the spring will be indicated by the spring compression indication hardware.

14. The jack of claim 13 wherein the jacking hardware comprises:
a first jacking member comprising:
a first force transmission portion located to rest on a top of the spring and sized, shaped and located to transmit trailer tongue weight forces from the trailer securing hardware, and
first axial alignment hardware; and
a second jacking member comprising:
a second force transmission portion sized, shaped and located to support a bottom of the spring so that the trailer tongue weight is transmitted from the first force transmission portion, through the spring to the second jacking member, and
second axial alignment hardware sized, shaped, located and/or connected to engage with the first axial alignment hardware so that the first jacking member can move relative to the second jacking member in a direction at least substantially parallel to the central axis and is prevented from moving laterally relative to the second jacking member.

15. The jack of claim 14 wherein:
the first axial alignment hardware is in the form of a sleeve;
the second axial alignment hardware is in the shape of a post extending in the axial direction; and
coaxial sliding engagement between the first axial alignment hardware and the second axial alignment hardware allows the first jacking member and second jacking member to move relative to each other in a direction at least substantially parallel to the central axis and prevents them from relative lateral motion.

16. The jack of claim 15 wherein the sleeve and post are shaped so that rotation of the first jacking member about the central axis will drive the second jacking member to rotate about the central axis.

17. The jack of claim 16 wherein:
the lower jack assembly includes a threaded member;
the second jacking member further comprises a threaded portion; and
the threaded member and threaded portion are located, sized and shaped to be in threaded engagement so that rotation of the second jacking member will move the upper jack assembly in the up and down directions relative to the lower jack assembly.

18. The jack of claim 13 further comprising a pivoting wheel connection sized, shaped, located and connected to mechanically connect the wheel to the lower jack assembly so that a rotational axis of the wheel is at least substantially perpendicular axis, and so that the wheel is free to pivot about the central axis.

19. The jack of claim 18 wherein the wheel is sized, shaped, connected and/or located so that the rotational axis of the wheel is offset from the central axis.
